(19) United States
(12) Patent Application Publication
(10) Pub. No.: US 2025/0350039 A1
(43) Pub. Date: Nov. 13, 2025

(54) RADIO WAVE CONTROL DEVICE AND RADIO WAVE CONTROL METHOD

(71) Applicant: KYOCERA CORPORATION, Kyoto-shi, Kyoto (JP)

(72) Inventors: Nobuki HIRAMATSU, Yokohama-shi, Kanagawa (JP); Masamichi YONEHARA, Yokohama-shi, Kanagawa (JP); Takuya HOTAKA, Yokohama-shi, Kanagawa (JP)

(21) Appl. No.: 18/995,469

(22) PCT Filed: Jul. 5, 2023
(86) PCT No.: PCT/JP2023/024892

§ 371 Date: Jan. 16, 2025

(30) Foreign Application Priority Data
Jul. 28, 2022 (JP) 2022-120687

(51) Int. Cl. H01Q 15/14; H01Q 3/20; H01Q 3/46; H01Q 15/00; H01Q 21/06

(52) U.S. Cl. CPC H01Q 15/14; H01Q 3/20; H01Q 15/0086; H01Q 3/46; H01Q 21/065

(57) ABSTRACT

A radio wave control device includes a casing, a radio wave control plate installed in the casing and configured to control an emission direction of an incident wave incident from a base station, and a rotation mechanism installed in the casing and configured to rotate the radio wave control plate on a first plane.

### TECHNICAL FIELD

The present disclosure relates to a radio wave control device and a radio wave control method.

### BACKGROUND OF INVENTION

A known technique includes controlling electromagnetic waves without using a dielectric lens. For example, Patent Document 1 describes a technique of refracting radio waves in a structure including an array of resonator elements by changing parameters of the respective resonator elements.

### CITATION LIST

### Patent Literature

Patent Document 1: JP 2015-231182 A

### SUMMARY

In the present disclosure, a radio wave control device includes a casing, a radio wave control plate, and a rotation mechanism. The radio wave control plate is installed in the casing and configured to control an emission direction of an incident wave incident from a base station. The rotation mechanism is installed in the casing and configured to rotate the radio wave control plate on a first plane.

In the present disclosure, a radio wave control method includes controlling an emission direction of an incident wave incident from a base station by a radio wave control plate installed in a casing, and controlling the emission direction by rotating the radio wave control plate on a first plane.

### BRIEF DESCRIPTION OF THE DRAWINGS

FIG. 1 is a diagram for explaining an outline of a wireless communication system according to a first embodiment.

FIG. 2 is a diagram illustrating a configuration of a radio wave control device according to the first embodiment.

FIG. 3A is a diagram illustrating a configuration example of a polygonal casing according to a first example of the first embodiment.

FIG. 3B is a diagram illustrating a configuration example of a polygonal casing according to a second example of the first embodiment.

FIG. 3C is a diagram illustrating a configuration example of a polygonal casing according to a third example of the first embodiment.

FIG. 4 is a diagram schematically illustrating an example of a radio wave control plate.

FIG. 5A is a diagram illustrating a configuration example of a radio wave control plate according to the first embodiment.

FIG. 5B is a diagram illustrating a configuration example of the radio wave control plate according to the first embodiment.

FIG. 5C is a diagram illustrating a configuration example of the radio wave control plate according to the first embodiment.

FIG. 6 is a schematic view illustrating a configuration example of a radio wave control plate according to a second embodiment.

FIG. 7 is a diagram for explaining a method of fixing the radio wave control plate according to the second embodiment to a rotary table.

FIG. 8 is a diagram for explaining a method of rotating a rotation mechanism according to a first example of the second embodiment from the outside of the casing.

FIG. 9 is a diagram illustrating a configuration example of a rotation mechanism according to a second example of the second embodiment.

FIG. 10 is a diagram illustrating a configuration example of a rotation mechanism according to a third example of the second embodiment.

FIG. 11 is a diagram for explaining a receivable area according to a comparative example of a third embodiment.

FIG. 12 is a diagram for explaining a receivable area according to the third embodiment.

FIG. 13 is a diagram for explaining an installation method of a radio wave control plate according to a comparative example of a fourth embodiment.

FIG. 14 is a diagram for explaining an installation method of a radio wave control plate according to the fourth embodiment.

FIG. 15A is a diagram illustrating a configuration example of a radio wave control plate according to a first example of a fifth embodiment.

FIG. 15B is a diagram illustrating a configuration example of a radio wave control plate according to a second example of the fifth embodiment.

FIG. 16 is a diagram illustrating a configuration example of a radio wave control device according to a sixth embodiment.

FIG. 17A is a diagram for explaining a phase distribution of a first radio wave control plate according to the sixth embodiment.

FIG. 17B is a diagram for explaining a phase distribution of a second radio wave control plate according to the sixth embodiment.

FIG. 18A is a diagram illustrating an example of a phase distribution obtained by superposition according to the sixth embodiment.

FIG. 18B is a diagram illustrating an example of the phase distribution obtained by the superposition according to the sixth embodiment.

FIG. 19 is a diagram for explaining a method of changing a focal position of a radio wave according to the sixth embodiment.

### DESCRIPTION OF EMBODIMENTS

In the following, embodiments of the present invention will be described in detail with reference to the accompanying drawings. The present invention is not limited by the embodiments, and in the following embodiments, the same reference signs are assigned to the same portions and redundant descriptions thereof will be omitted.

In the following description, an XYZ orthogonal coordinate system is set, and the positional relationship between respective portions will be described by referring to the XYZ orthogonal coordinate system. A direction parallel to an X axis in a horizontal plane is defined as an X axis direction, a direction parallel to a Y axis orthogonal to the X axis in the horizontal plane is defined as a Y axis direction, and a direction parallel to a Z axis orthogonal to the horizontal plane is defined as a Z axis direction. A plane including the X axis and the Y axis is appropriately referred to as an XY plane, a plane including the X axis and the Z axis is appropriately referred to as an XZ plane, and a plane including the Y axis and the Z axis is appropriately referred to as a YZ plane. The XY plane is parallel to the horizontal plane. The XY plane, the XZ plane, and the YZ plane are orthogonal to each other.

### First Embodiment

### Wireless Communication System

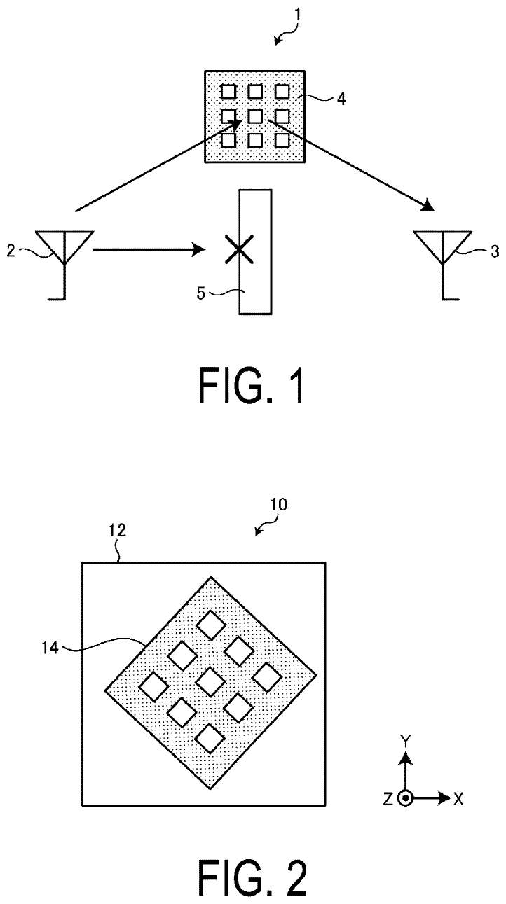

An outline of a wireless communication system according to a first embodiment will be described using FIG. 1. FIG. 1 is a diagram for explaining the outline of the wireless communication system according to the first embodiment.

As illustrated in FIG. 1, a wireless communication system 1 includes a base station 2, a terminal 3, and a radio wave control plate 4. When an obstacle 5 exists between the base station 2 and the terminal 3, a radio wave transmitted from the base station 2 to the terminal 3 is blocked by the obstacle 5. In the wireless communication system 1, the radio wave control plate 4 reflects or refracts the radio wave from the base station 2 to allow the terminal 3 to receive the radio wave under an environment where the obstacle 5 exists and blocks the radio wave between the base station 2 and the terminal 3.

In a case in which the radio wave control plate 4, for example, cannot electrically control a reflection direction or a refraction direction of the radio wave, when a positional relationship between the terminal 3 and the radio wave control plate 4 is changed, there is a possibility that communication between the base station 2 and the terminal 3 is not established. Therefore, in the present disclosure, the radio wave control plate is installed in a casing, and this radio wave control plate is rotated in the casing to change the reflection direction or the refraction direction of the radio wave.

### Radio Wave Control Device

A configuration example of a radio wave control device according to the first embodiment will be described using FIG. 2. FIG. 2 is a diagram illustrating a configuration of the radio wave control device according to the first embodiment.

As illustrated in FIG. 2, a radio wave control device 10 includes a casing 12 and a radio wave control plate 14. The radio wave control plate 14 is disposed inside the casing 12. The radio wave control plate 14 is rotatable in an XY plane inside the casing 12.

The casing 12 is a box in which the radio wave control plate 14 can be installed. The casing 12 is made of a material that has a low dielectric constant and can transmit a radio wave. The casing 12 is preferably made of a resin that can transmit a radio wave. Examples of the resin for the casing 12 include, but are not limited to, an ABS resin, a polycarbonate resin, a polyethylene resin, an acrylic resin, and a Teflon (registered trademark) resin. The casing 12 is preferably formed in a regular polygonal shape or a circular shape when viewed from a Z axis direction.

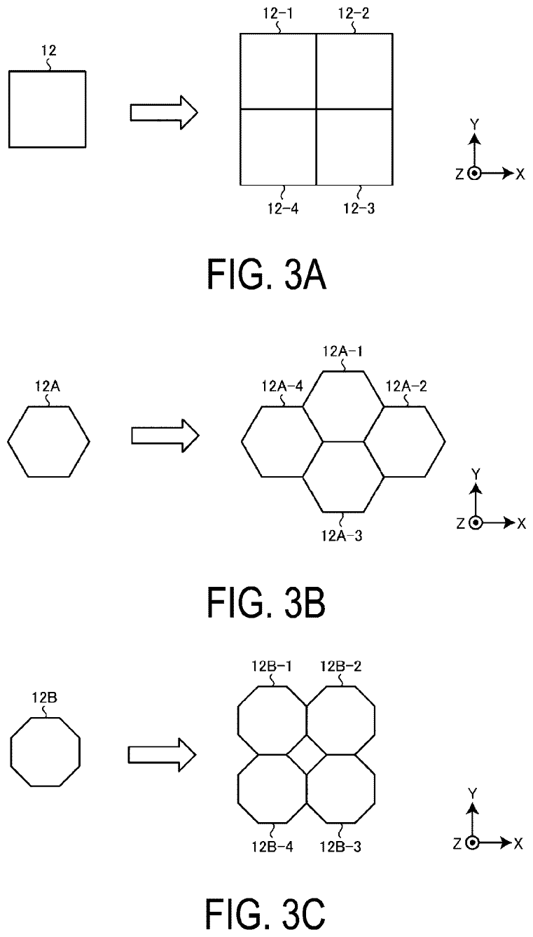

FIG. 3A is a diagram illustrating a configuration example of a polygonal casing according to a first example of the first embodiment. As illustrated in FIG. 3A, the casing 12 according to the first example of the first embodiment is formed in a quadrilateral shape when viewed from the Z axis direction. The casing 12 may include, for example, a coupling portion that can be coupled to another casing 12. As a result, in the first example of the first embodiment, four casings 12 including a casing 12-1, a casing 12-2, a casing 12-3, and a casing 12-4 can be coupled to each other.

FIG. 3B is a diagram illustrating a configuration example of a polygonal casing according to a second example of the first embodiment. As illustrated in FIG. 3B, a casing 12A according to the second example of the first embodiment has a hexagonal shape when viewed from the Z axis direction. The casing 12A may include, for example, a coupling portion that can be coupled to another casing 12A. As a result, in the second example of the first embodiment, four casings 12A including a casing 12A-1, a casing 12A-2, a casing 12A-3, and a casing 12A-4 can be coupled to each other.

FIG. 3C is a diagram illustrating a configuration example of a polygonal casing according to a third example of the first embodiment. As illustrated in FIG. 3C, a casing 12B according to the third example of the first embodiment is formed in an octagonal shape when viewed from the Z axis direction. The casing 12B may include, for example, a coupling portion that can be coupled to another casing 12B. As a result, in the third example of the first embodiment, four casings 12B including a casing 12B-1, a casing 12B-2, a casing 12B-3, and a casing 12B-4 can be coupled to each other.

Return to FIG. 2. The radio wave control plate 14 is installed inside the casing 12. The radio wave control plate 14 can be disposed inside the casing 12 by opening any one of the faces of the casing 12, for example. The radio wave control plate 14 is a plate-shaped member that can transmit or reflect the radio wave transmitted from the base station 2. The radio wave control plate 14 includes a radio wave refraction plate that refracts the radio wave in a predetermined direction, and a radio wave reflection plate that reflects the radio wave in a predetermined direction. Upon receipt of the radio wave transmitted from the base station 2, the radio wave control plate 14 refracts or reflects the radio wave in a direction of the terminal and emits the radio wave toward the terminal. The radio wave control plate 14 may be made of, for example, a metamaterial that changes a phase of an incident wave.

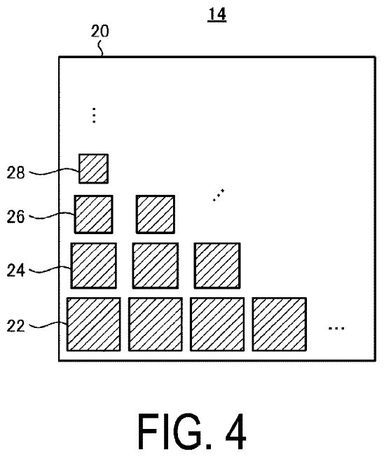

FIG. 4 is a diagram schematically illustrating an example of the radio wave control plate 14. As illustrated in FIG. 4, the radio wave control plate 14 may include a substrate 20 and elements 22, elements 24, elements 26, and elements 28, for example.

The elements 22, the elements 24, the elements 26, and the elements 28 may be formed on the substrate 20. The substrate 20 may have a rectangular shape, for example, but is not limited thereto. The elements 22, the elements 24, the elements 26, and the elements 28 may be two-dimensionally arranged on the substrate 20. Specifically, in FIG. 2, a plurality of elements 22 may be arranged in a line in the bottom row of the substrate 20. On the substrate 20, a plurality of elements 24 may be arranged in a line in a row above the row where the elements 22 are arranged. On the substrate 20, a plurality of elements 26 may be arranged in a line in a row above the row where the elements 24 are arranged. On the substrate 20, a plurality of elements 28 may be arranged in a line in a row above the row where the elements 26 are arranged. That is, the radio wave control plate 14 may have a structure in which the plurality of elements having different sizes are periodically arrayed. The elements 22 to the elements 28 may be different in the frequency band of the radio wave to be changed and the amount of change in the phase. Each of the elements 22 to the elements 28 has the rectangular shape, but is not limited thereto. The frequency band and the amount of change in the phase of the radio wave to be refracted or reflected can be adjusted by changing the size and shape of the elements 22, the elements 24, the elements 26, and the elements 28.

As illustrated in FIG. 2, the radio wave control plate 14 is formed in a quadrilateral shape when viewed from the Z axis direction. The radio wave control plate 14 is preferably formed in a polygonal shape when viewed from the Z axis direction.

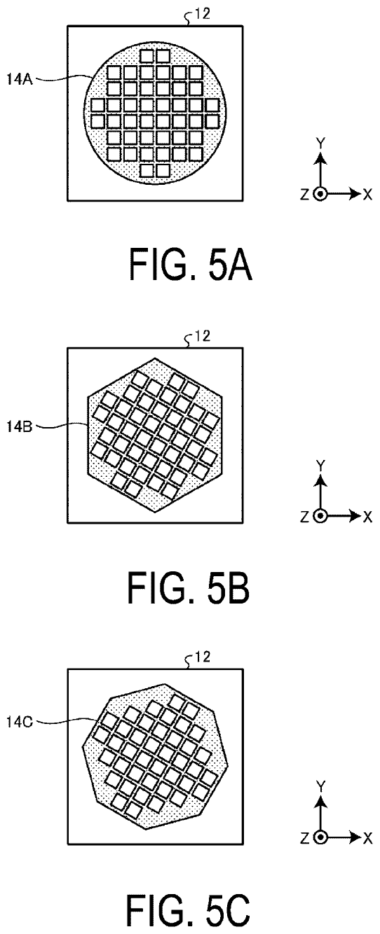

FIGS. 5A, 5B and 5C are diagrams illustrating configuration examples of the radio wave control plate according to the first embodiment. As illustrated in FIG. 5A, a radio wave control plate 14A is preferably formed in a circular shape when viewed from the Z axis direction. As illustrated in FIG. 5B, a radio wave control plate 14B is preferably formed in a hexagonal shape when viewed from the Z axis direction. As illustrated in FIG. 5C, a radio wave control plate 14C is preferably formed in an octagonal shape when viewed from the Z axis direction.

As a method of rotating the radio wave control plate 14, for example, the casing 12 may be opened, from which the radio wave control plate 14 may be removed. Then, the casing 12 may be rotated so that the radio wave is reflected or refracted in a desired direction, and the radio wave control plate 14 may be installed in the casing 12 again. Accordingly, in the first embodiment, the reflection direction and the refraction direction of the radio wave on the radio wave control plate 14 whose directivity is predetermined at the time of design can be easily changed. Further, in the first embodiment, the radio wave control plate 14 may be disposed to be inclined with respect to the XY plane.

### Second Embodiment

### Radio Wave Control Device

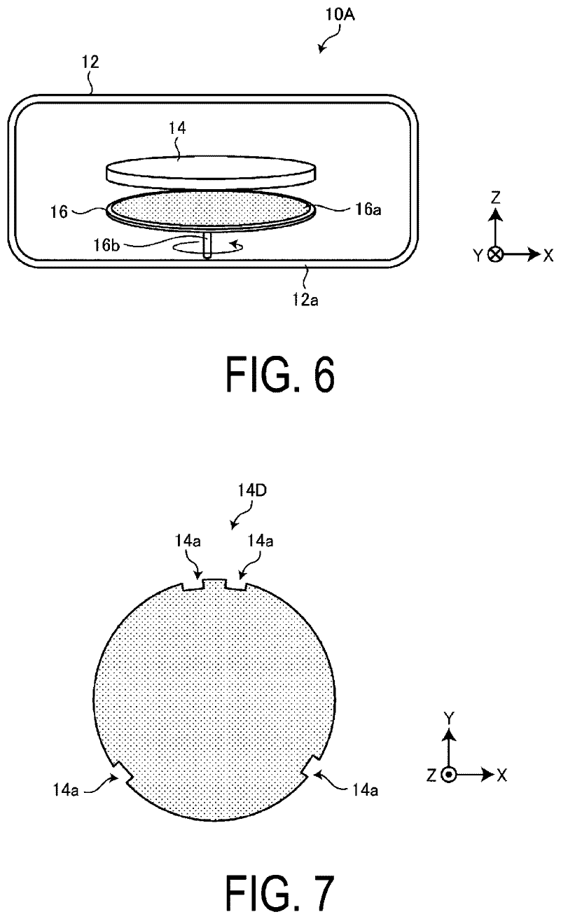

A second embodiment of the present disclosure will be described. FIG. 6 is a schematic view illustrating a configuration example of a radio wave control plate according to the second embodiment.

As illustrated in FIG. 6, a radio wave control device 10A includes a casing 12, a radio wave control plate 14, and a rotation mechanism 16. The radio wave control plate 14 and the rotation mechanism 16 are disposed in the casing 12. The radio wave control plate 14 of a radio wave control device 10 can be rotated in the XY plane by the rotation mechanism 16.

The rotation mechanism 16 includes a rotary table 16a and a shaft portion 16b. The rotary table 16a is, for example, a flat plate formed in a circular shape when viewed from the Z axis direction. The shaft portion 16b is provided at the center of the rotary table 16a. In the rotation mechanism 16, the rotary table 16a rotates about the shaft portion 16b on the XY plane in the direction indicated by an arrow. The rotation mechanism 16 is installed inside the casing 12 so that the rotary table 16a can be rotated on the XY plane by a user's operation from the outside of the casing 12. The rotation mechanism 16 is installed inside the casing 12 so as to rotate the rotary table 16a on the XY plane by the shaft portion 16b inserted into a bottom surface 12a of the casing 12, for example.

The radio wave control plate 14 is installed on the rotary table 16a. To be specific, the radio wave control plate 14 is fixed to the rotary table 16a so as not to move on the rotation mechanism 16. FIG. 7 is a diagram for explaining a method of fixing a radio wave control plate 14D according to the second embodiment to the rotary table 16a. As illustrated in FIG. 7, the radio wave control plate 14D includes a plurality of notch portions 14a.

The notch portion 14a is obtained by cutting out a part of the periphery of a substrate of the radio wave control plate 14D. The notch portion 14a can be coupled to a protruding portion (not illustrated) formed on the rotary table 16a. The radio wave control plate 14D is fixed to the rotary table 16a by coupling the notch portion 14a to the protruding portion (not illustrated) formed on the rotary table 16a.

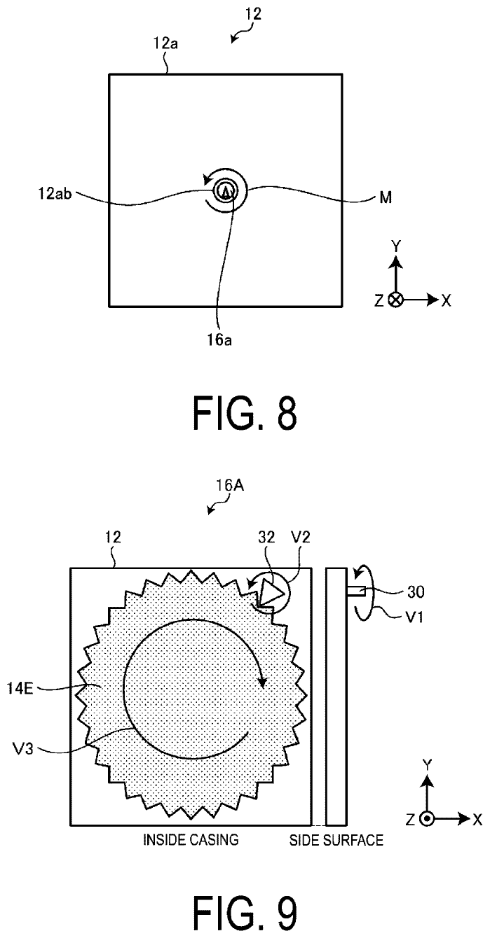

FIG. 8 is a diagram for explaining a method of rotating the rotation mechanism 16 according to a first example of the second embodiment from the outside of the casing 12. FIG. 8 illustrates the bottom surface 12a of the casing 12 on which the rotation mechanism 16 is installed, when viewed from the outside. As illustrated in FIG. 8, a hole portion 12ab is formed on the bottom surface 12a. The shaft portion 16b of the rotation mechanism 16 installed inside the casing 12 is exposed from the hole portion 12ab. A marker M is provided around the hole portion 12ab. The marker M is, for example, provided by laser marking. The marker M is an arrow that indicates a rotation direction of the rotation mechanism 16. The user can rotate the rotary table 16a on the XY plane by rotating the shaft portion 16b in the direction of the arrow indicated by the marker M.

FIG. 9 is a diagram illustrating a configuration example of a rotation mechanism according to a second example of the second embodiment. As illustrated in FIG. 9, in a rotation mechanism 16A, a substrate of a radio wave control plate 14E is formed in a gear shape in which a plurality of teeth are formed on the outer periphery.

The rotation mechanism 16A includes a shaft portion 30 provided on a side surface of the casing 12 and a tooth portion 32 provided inside the casing 12. The shaft portion 30 and the tooth portion 32 are coupled to each other. The tooth portion 32 meshes with the teeth on the outer periphery of the radio wave control plate 14E.

When a user rotates the shaft portion 30 in the direction of an arrow V1, the tooth portion 32 of the rotation mechanism 16A rotates in the direction of an arrow V2. Since the tooth portion 32 meshes with the teeth on the outer periphery of the radio wave control plate 14E, when the tooth portion 32 rotates in the direction of the arrow V2, the radio wave control plate 14E rotates in the direction of an arrow V3. That is, the user can rotate the radio wave control plate 14E in the direction of the arrow V3 by rotating the shaft portion 30 in the direction of the arrow V1.

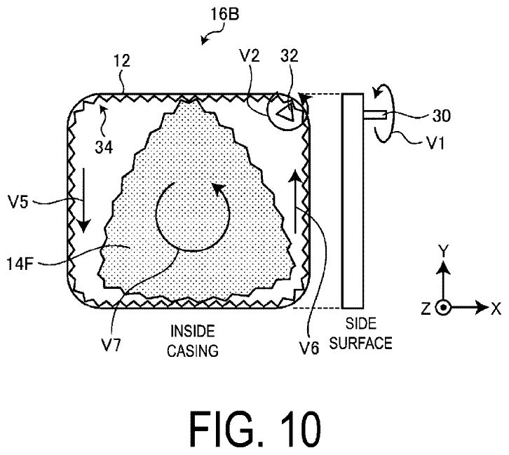

FIG. 10 is a diagram illustrating a configuration example of a rotation mechanism according to a third example of the second embodiment. As illustrated in FIG. 10, in a rotation mechanism 16B, a plurality of teeth are formed on the outer periphery of a substrate of a radio wave control plate 14F. The outer periphery is formed in a curve of constant width which is a curve of constant width. The curve of constant width refers to a closed curve whose width across the outer periphery is fixed. Examples of the curve of constant width include a circle and a Reuleaux polygon. In the example illustrated in FIG. 10, a plurality of teeth are formed on the outer periphery of the substrate of the radio wave control plate 14F, and the substrate is formed in a Reuleaux triangle shape. The substrate of the radio wave control plate 14F is not limited to the Reuleaux triangle, but may be formed in the Reuleaux polygon.

The rotation mechanism 16B includes the shaft portion 30 provided on a side surface of the casing 12, the tooth portion 32 provided inside the casing 12, and a conveyor 34 provided along an inside wall of the casing 12 and having a plurality of teeth formed on an inner periphery of the conveyor 34. The teeth of the radio wave control plate 14F mesh with the teeth of the conveyor 34. The tooth portion 32 meshes with the teeth of the conveyor 34.

When a user rotates the shaft portion 30 in the direction of the arrow V1, the tooth portion 32 of the rotation mechanism 16B rotates in the direction of the arrow V2. Since the tooth portion 32 meshes with the teeth of the conveyor 34, when the tooth portion 32 rotates in the direction of the arrow V2, the conveyor 34 rotates along the inner periphery of the casing 12 as indicated by an arrow V5 and an arrow V6. Since the teeth of the conveyor 34 mesh with the teeth of the radio wave control plate 14F, when the conveyor 34 rotates as indicated by the arrow V5 and the arrow V6, the radio wave control plate 14F rotates in the direction of an arrow V7. That is, the user can rotate the radio wave control plate 14F in the direction of the arrow V7 by rotating the shaft portion 30 in the direction of the arrow V1.

As described above, in the second embodiment, the radio wave control plate installed in the casing can be rotated from the outside of the casing. In the second embodiment, the reflection direction and the refraction direction of the radio wave on the radio wave control plate whose directivity is predetermined at the time of design can be easily changed.

### Third Embodiment

A third embodiment of the present disclosure will be described. In the case of controlling a receivable area of a radio wave by rotating a radio wave control plate installed in a casing and accordingly changing a reflection direction or a refraction direction, a problem that the receivable area cannot be effectively changed occurs when a refraction angle or a reflection angle is relatively small for a beam width of the radio wave. For example, the beam width is defined as a range where the power of a beam of radio wave emitted from the radio wave control plate is half the maximum power within a distance between the radio wave control plate and a terminal or a base station.

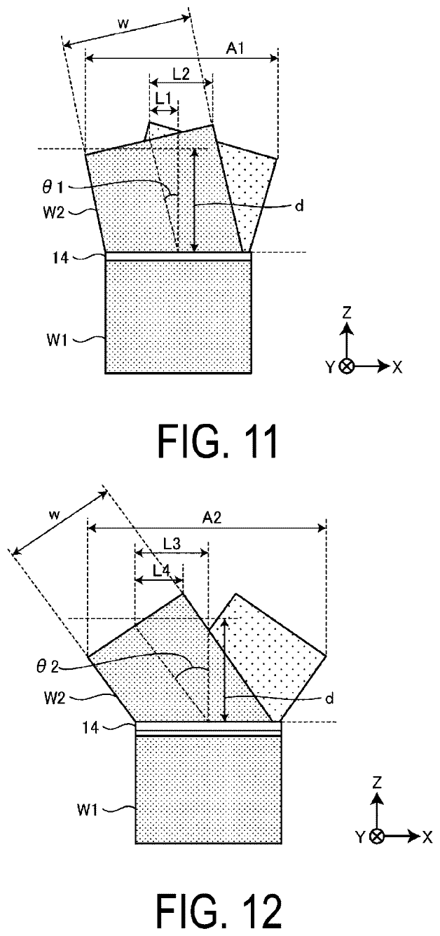

FIG. 11 is a diagram for explaining a receivable area according to a comparative example of the third embodiment. FIG. 11 schematically illustrates how a radio wave W1 incident on a radio wave control plate 14 is refracted. In FIG. 11, a distance between the radio wave control plate 14 and the terminal or the base station is d, the refraction angle of the radio wave is θ1, and the beam width of the radio wave W1 is w in which a gain drops by 3 dB at the position with the distance d from the radio wave control plate 14. In this case, d·tan θ1 is a distance L1, and w/2·cos θ1 is a distance L2. In the example illustrated in FIG. 11, the refraction angle θ1 is relatively small for the beam width w, and the condition d·tan θ1<w/2·cos θ1 is satisfied. In this case, a receivable area of a radio wave W2 from the radio wave control plate 14 is an area A1. The area A1 is an annular range when viewed from the Z axis direction.

FIG. 12 is a diagram for explaining a receivable area according to the third embodiment. FIG. 12 schematically illustrates how the radio wave W1 incident on the radio wave control plate 14 is refracted. In FIG. 12, the distance between the radio wave control plate 14 and the terminal is d, the refraction angle of the radio wave is θ2, and the beam width of the radio wave W1 is w in which the gain drops by 3 dB at the position with the distance d from the radio wave control plate 14. In this case, d·tan θ2 is a distance L3 and w/2·cos θ2 is a distance L4. In the example illustrated in FIG. 12, the refraction angle θ2 is relatively large for the beam width w, and the condition d·tan θ2≥w/2·cos θ2 is satisfied. In this case, the receivable area of the radio wave W2 from the radio wave control plate 14 is an area A2. The area A2 is an annular range when viewed from the Z axis direction.

When compared to the area A1 illustrated in FIG. 11, the area A2 illustrated in FIG. 12 is wider. That is, when the refraction angle or the reflection angle of the radio wave of the radio wave control plate 14 is θ, the receivable area can be effectively changed by satisfying the condition of d·tan θ≥w/2·cos θ.

### Fourth Embodiment

A fourth embodiment of the present disclosure will be described. In a case in which a radio wave is refracted by a radio wave control plate installed in a casing, when the radio wave control plate is installed to be inclined with respect to a base station, an effective area in a refraction direction of the radio wave may be reduced at the time of rotating the radio wave control plate. There is a possibility that reception power may decrease.

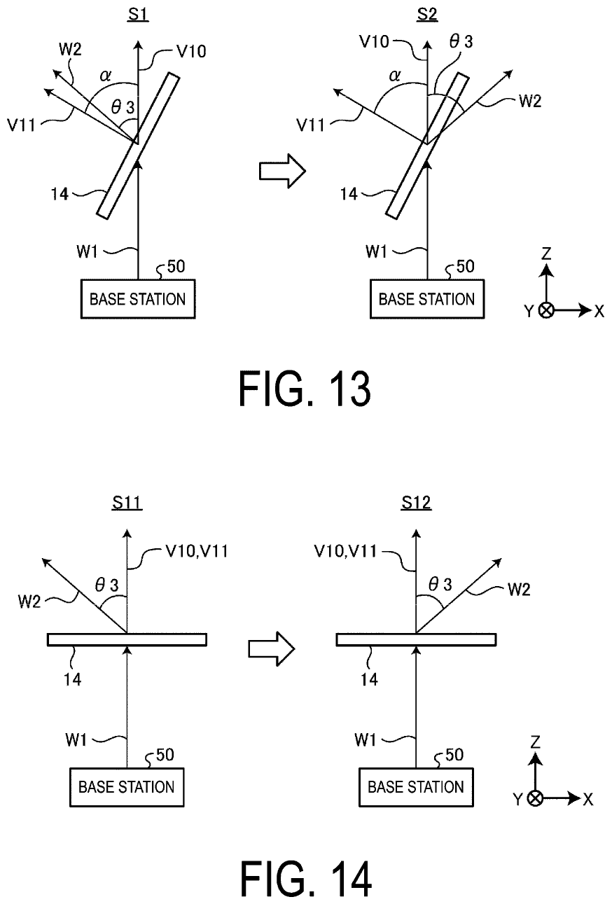

FIG. 13 is a diagram for explaining an installation method of a radio wave control plate according to a comparative example of the fourth embodiment. FIG. 13 schematically illustrates how the radio wave from a base station 50 is refracted and emitted. An arrow V10 indicates a direction connecting the base stations 50 and the center of a radio wave control plate 14. An arrow V11 indicates a normal direction of the radio wave control plate 14.

As illustrated in step S1, the radio wave control plate 14 is installed with an installation angle α formed by the arrow V10 and the arrow V11. The radio wave control plate 14 refracts a radio wave W1 from the base station and emits a radio wave W2. A refraction angle of the radio wave W1 is θ3. The installation angle α is larger than the refraction angle θ3.

In step S2, the radio wave control plate 14 is rotated by 180°. That is, the right side and left side of the radio wave control plate 14 are reversed. As illustrated in FIG. 13, when the right side and left side of the radio wave control plate 14 are reversed, an emission direction of the radio wave W2 is also reversed. Since the radio wave control plate 14 is inclined with respect to the base station 50, when the emission direction of the radio wave W2 is reversed, the effective area in the refraction direction of the radio wave W1 may be reduced. The reception power may decrease accordingly.

FIG. 14 is a diagram for explaining an installation method of a radio wave control plate according to the fourth embodiment. FIG. 14 schematically illustrates how the radio wave from the base station 50 is refracted and emitted. The arrow V10 indicates a direction connecting the base station 50 and the center of the radio wave control plate 14. The arrow V11 indicates a normal direction of the radio wave control plate 14.

As illustrated in step S11, the radio wave control plate 14 is installed so that the arrow V10 and the arrow V11 coincide with each other. That is, the installation angle formed by the arrow V10 and the arrow V11 is 0°. That is, in the fourth embodiment, the installation angle α is smaller than the refraction angle θ3.

In step S12, the radio wave control plate 14 is rotated by 180° so that the right side and left side of the radio wave control plate 14 are reversed. As illustrated in FIG. 14, when the right side and left side of the radio wave control plate 14 are reversed, the emission direction of the radio wave W2 is also reversed. Since the radio wave control plate 14 is not inclined with respect to the base station 50, even when the emission direction of the radio wave W2 is reversed, the reception power is not decreased.

That is, the radio wave control plate 14 is preferably installed so that the angle formed by a straight line connecting the base station 50 and the center of the radio wave control plate 14 and a normal line of the radio wave control plate 14 is smaller than the refraction angle of the radio wave control plate 14. More preferably, the angle between the straight line connecting the center of the radio wave control plate 14 and the normal line of the radio wave control plate 14 is 0°. Accordingly, in the fourth embodiment, a decrease in reception sensitivity due to the rotation of the radio wave control plate 14 can be suppressed.

### Fifth Embodiment

A fifth embodiment of the present disclosure will be described. Reduction of the size of a radio wave control plate is advantageous to rotate the radio wave control plate in a casing. However, reduction of the size of the radio wave control plate causes a problem that reception power is decreased. When the size of the radio wave control plate is increased in order to improve the reception power, there is a possibility that the radio wave control plate cannot be rotated inside the casing.

In the fifth embodiment, the surface shape of the radio wave control plate is a curve of constant width which is a curve of constant width, thereby improving the reception power.

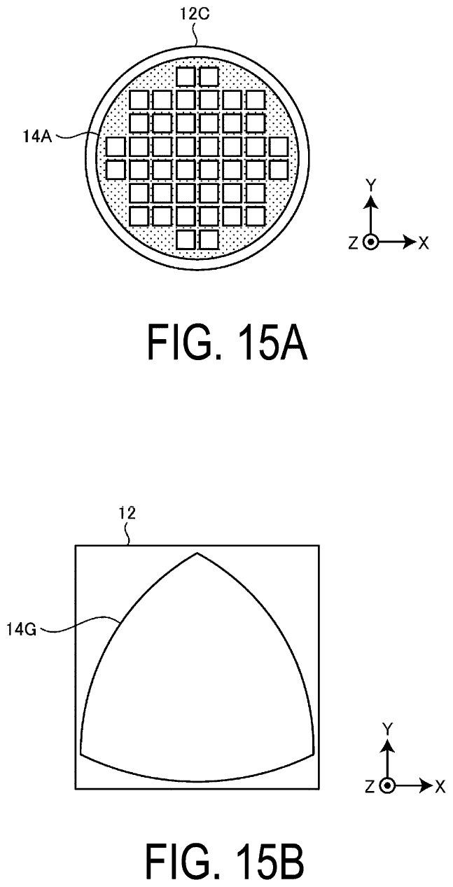

FIG. 15A is a diagram illustrating a configuration example of a radio wave control plate according to a first example of the fifth embodiment. As illustrated in FIG. 15A, in a case in which a casing 12C has a circular shape when viewed from the Z axis direction, a radio wave control plate 14A preferably has a circular shape when viewed from the Z axis direction. When the casing 12C has a circular shape when viewed from the Z axis direction, the shape of the radio wave control plate may be a Reuleaux polygon when viewed from the Z axis direction.

FIG. 15B is a diagram illustrating a configuration example of a radio wave control plate according to a second example of the fifth embodiment. As illustrated in FIG. 15B, in a case in which the casing 12 has a polygonal shape such as a quadrilateral shape when viewed from the Z axis direction, a radio wave control plate 14G may have a Reuleaux triangle shape when viewed from the Z axis direction. In a case in which the casing 12 has the polygonal shape such as a quadrilateral shape when viewed from the Z axis direction, the shape of the radio wave control plate may be a circle or the Reuleaux polygon other than the Reuleaux triangle when viewed from the Z axis direction.

For example, as viewed from the Z axis direction, in a case in which the shape of the casing 12 viewed from the Z axis direction is a square with one side having a length L, when the radio wave control plate having a square shape viewed from the Z axis direction is installed in the casing 12 and rotated, the length of one side needs to be L/(√2). In this case, the area of the radio wave control plate is (L\hat{ }2)/2.

On the other hand, as viewed from the Z axis direction, in a case in which the shape of the casing 12 viewed from the Z axis direction is a square with one side having a length L, when the radio wave control plate having a circular shape viewed from the Z axis direction is installed in the casing 12 and rotated, the length of the diameter can be set to L. In this case, the area of the radio wave control plate is (π/4)L\hat{ }2.

That is, in casings 12 of the same size, the area ratio between a rotatable radio wave control plate having the square shape and a rotatable radio wave control plate having the circular shape is: Area of the radio wave control plate having the square shape:Area of the radio wave control plate having the circular shape=2: π. When this is converted into a gain under the far field condition, the radio wave control plate having the circular shape has a higher gain by about 2.0 dB than the radio wave control plate having the square shape. When this is converted into reception power, the reception power of the radio wave control plate having the circular shape is 1.6 times higher than that of the radio wave control plate having the square shape.

In addition, as viewed from the Z axis direction, in a case in which the shape of the casing 12 viewed from the Z axis direction is a square with one side having a length L, the shape in which the area of the radio wave control plate is minimum among curves of constant width that are rotatable inside the casing 12 is the Reuleaux triangle. In casings 12 of the same size, the area ratio between a rotatable radio wave control plate having the square shape and a rotatable radio wave control plate having the circular shape is: Area of the radio wave control plate having the square shape:Area of the radio wave control plate having the circular shape=1:1.41. When this is converted into a gain under the far field condition, the radio wave control plate having the Reuleaux triangle has a higher gain by about 1.5 dB than the radio wave control plate having the square shape. When this is converted into reception power, the reception power of the radio wave control plate having the Reuleaux triangle is 1.4 times higher than that of the radio wave control plate having the square shape.

That is, in the fifth embodiment, by forming the surface shape of the radio wave control plate into a curve of constant width, the gain of the reception power in a far field can be increased by 1.5 dB or more.

### Sixth Embodiment

A sixth embodiment of the present disclosure will be described. When a radio wave control plate whose surface shape is a curve of constant width is rotated and used inside a casing, there is a problem that adjustment of the position of a focal point is difficult when electrical power is desired to be concentrated on a specific point. Examples of the case where electrical power is desired to be concentrated on the specific point include, but are not limited to, a case where loss of electrical power due to a medium such as heat reflecting glass is desired to be compensated by converging radio waves. In the sixth embodiment, a phase distribution of the radio wave control plate is configured to be concentric. The phase distribution can be varied, and a focal distance can be varied accordingly. In the sixth embodiment, a mechanism is further provided to vary a focal position by rotating the radio wave control plate with the center of the concentric phase distribution shifted from the rotation center.

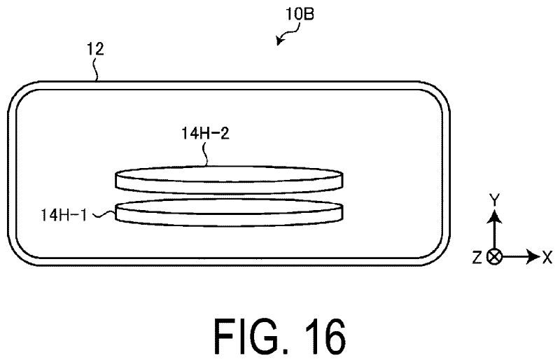

FIG. 16 explains a configuration example of a radio wave control device according to the sixth embodiment. FIG. 16 is a diagram illustrating a configuration example of the radio wave control device according to the sixth embodiment.

FIG. 16 schematically illustrates a radio wave control device 10B according to the sixth embodiment. As illustrated in FIG. 16, the radio wave control device 10B includes a casing 12, a first radio wave control plate 14H-1, and a second radio wave control plate 14H-2. That is, the radio wave control device 10B includes a plurality of radio wave control plates. The first radio wave control plate 14H-1 and the second radio wave control plate 14H-2 are disposed to superpose each other along the Z axis direction. The radio wave control device 10B includes a rotation mechanism (not illustrated) that can independently rotate the first radio wave control plate 14H-1 and a radio wave control plate 14-2 in the XY plane. As the rotation mechanism, for example, the rotation mechanism 16 illustrated in FIG. 6, the rotation mechanism 16A illustrated in FIG. 9, or the rotation mechanism 16B illustrated in FIG. 10 can be used, but the rotation mechanism is not limited thereto.

The radio wave control device 10B changes the focal distance using the principle of a moire lens by independently rotating two radio wave control plates, the first radio wave control plate 14H-1 and the second radio wave control plate 14H-2, in the XY plane.

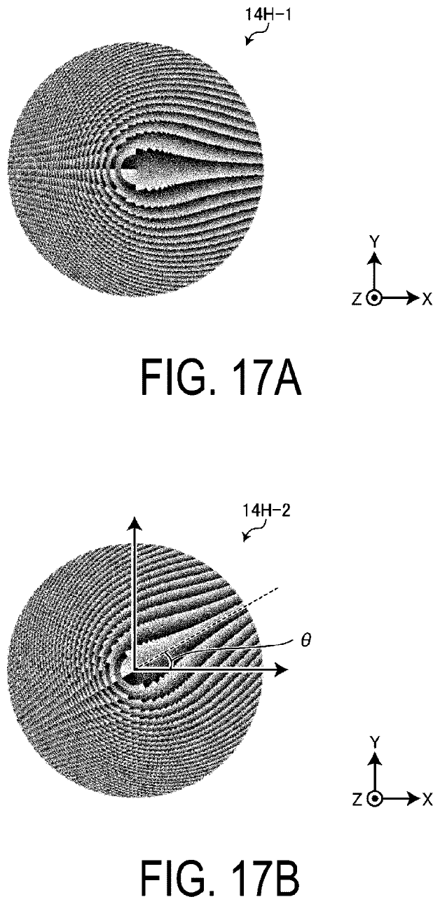

Using FIGS. 17A and 17B, the phase distribution of the radio wave control plate according to the sixth embodiment will be described. FIG. 17A is a diagram for explaining a phase distribution of the first radio wave control plate according to the sixth embodiment. FIG. 17B is a diagram for explaining a phase distribution of the second radio wave control plate according to the sixth embodiment.

FIG. 17A illustrates the phase distribution of the first radio wave control plate 14H-1. In FIG. 17A, a shade of color indicates an amount of phase change. For example, as the color is darker, the amount of phase change increases, while the color is lighter, the amount of phase change decreases. In the first radio wave control plate 14H-1, the amount of phase change varies concentrically.

FIG. 17B illustrates the phase distribution of the second radio wave control plate 14H-2. The second radio wave control plate 14H-2 has, for example, the phase distribution which is the same as and/or similar to that of the first radio wave control plate 14H-1. The second radio wave control plate 14H-2 is disposed inside the casing 12, while being rotated by a predetermined angle θ (θ=30° in FIG. 17B) with respect to the phase distribution of the first radio wave control plate 14H-1. When a relative angle of the phase distribution of the second radio wave control plate 14H-2 with respect to the phase distribution of the first radio wave control plate 14H-1 changes, a phase distribution obtained by superposition of the first radio wave control plate 14H-1 and the second radio wave control plate 14H-2 changes.

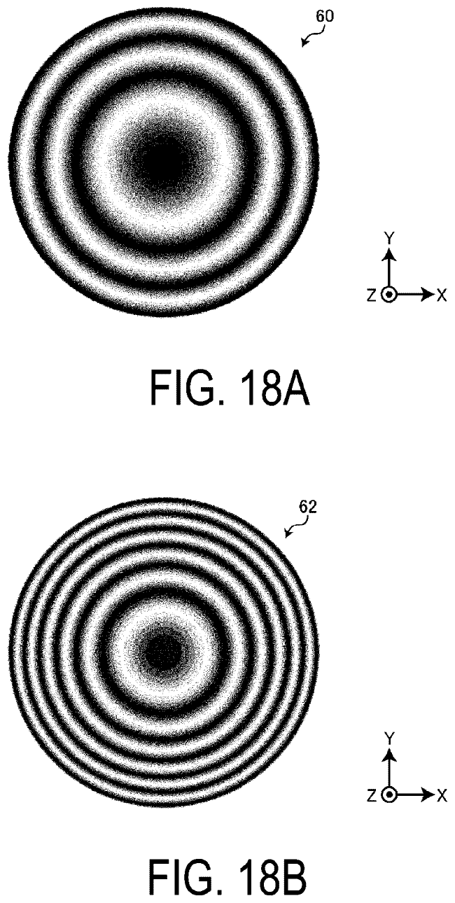

FIGS. 18A and 18B are diagrams illustrating examples of the phase distribution obtained by the superposition according to the sixth embodiment. FIG. 18A illustrates a phase distribution 60 obtained by the superposition when the relative angle of the phase distribution of the second radio wave control plate 14H-2 with respect to the phase distribution of the first radio wave control plate 14H-1 is 15°. FIG. 18B illustrates a phase distribution 62 obtained by the superposition when the relative angle of the phase distribution of the second radio wave control plate 14H-2 with respect to the phase distribution of the first radio wave control plate 14H-1 is 30°. As illustrated by the phase distribution 60 and the phase distribution 62, when the relative angle of the phase distribution of the second radio wave control plate 14H-2 with respect to the phase distribution of the first radio wave control plate 14H-1 changes, moire of the phase distribution changes. Thus, the focal distance can be changed.

A method of changing the focal position of the radio wave will be described. As described in FIGS. 18A and 18B, the focal distance of the radio wave is changed by changing the relative angle of the phase distribution of the second radio wave control plate 14H-2 with respect to the phase distribution of the first radio wave control plate 14H-1. In order to change the focal position of the radio wave, the first radio wave control plate 14H-1 and the second radio wave control plate 14H-2 may be rotated in their entirety about a rotation center at a position different from the center of the phase distribution obtained by the superposition of the first radio wave control plate 14H-1 and the second radio wave control plate 14H-2.

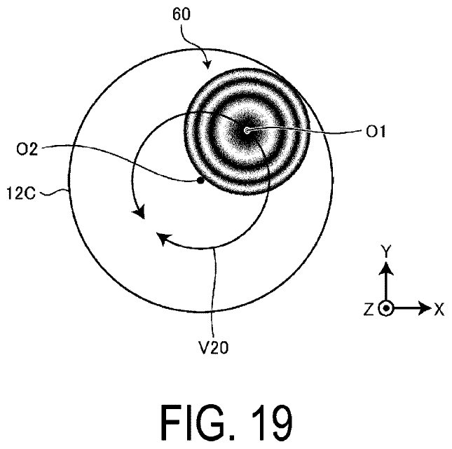

FIG. 19 is a diagram for explaining a method of changing the focal position of the radio wave according to the sixth embodiment. In the example illustrated in FIG. 19, the first radio wave control plate 14H-1 and the second radio wave control plate 14H-2 are assumed to be disposed inside the casing 12 having a circular shape when viewed from the Z axis direction.

A phase center O1 indicates the center of the phase distribution 60 obtained by the superposition of the first radio wave control plate 14H-1 and the second radio wave control plate 14H-2. A rotation center O2 indicates the rotation center of the first radio wave control plate 14H-1 and the second radio wave control plate 14H-2 in their entirety inside the casing 12. When the first radio wave control plate 14H-1 and the second radio wave control plate 14H-2 are rotated about the rotation center O2 by a rotation mechanism (not illustrated), the phase center O1 moves on an arrow V20. As described above, by moving the position of the phase center O1 inside the casing 12C, the focal position of the radio wave can be changed.

As described above, in the sixth embodiment, the focal position of the radio wave can be changed by changing the relative angle between the phase distributions of the two radio wave control plates.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### REFERENCE SIGNS

1 Wireless communication system
2 Base station
3 Terminal
4 Radio wave control plate
10, 10A, 10B Radio wave control device
12, 12A, 12B, 12C Casing
14, 14A, 14B, 14C, 14D, 14E, 14F, 14G Radio wave control plate
14H-1 First radio wave control plate
14H-2 Second radio wave control plate
16, 16A, 16B Rotation mechanism

1. A radio wave control device, comprising:
a casing;
at least one radio wave control plate installed in the casing and configured to control an emission direction of an incident wave incident from a base station; and
a rotation mechanism installed in the casing and configured to rotate the radio wave control plate on a first plane.

2. The radio wave control device according to claim 1, wherein
when a distance between the radio wave control plate and a terminal or a base station that receives an emission wave emitted from the radio wave control plate is d, a reflection angle or a refraction angle of the incident wave at the radio wave control plate is θ, and a beam width of the emission wave is w, the following expression (1) is satisfied.

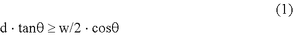

3. The radio wave control device according to claim 2, wherein
the radio wave control plate is installed with an angle formed between a straight line connecting the radio wave control plate and the base station and a normal direction of the radio wave control plate, the angle being smaller than a refraction angle of the incident wave at the radio wave control plate.

4. The radio wave control device according to claim 2, wherein
the radio wave control plate has an outer shape with a constant width figure.

5. The radio wave control device according to claim 1, further comprising a plurality of the radio wave control plates having different phase distributions, wherein
the rotation mechanism is configured to rotate at least one of a plurality of the radio wave control plates on the first plane, and change a relative angle between the phase distributions of the plurality of the radio wave control plates.

6. A radio wave control method comprising:
controlling an emission direction of an incident wave incident from a base station by a radio wave control plate installed in a casing; and
controlling the emission direction by rotating the radio wave control plate on a first plane.
